(19) United States
(12) Patent Application Publication
(10) Pub. No.: US 2013/0072124 A1
(43) Pub. Date: Mar. 21, 2013

(54) METHOD AND SYSTEM FOR ANALOG BEAMFORMING IN WIRELESS COMMUNICATION SYSTEMS

(71) Applicants: IMEC, Leuven (BE); Katholieke Universiteit Leuven, Leuven (BE)

(72) Inventor: Jimmy Nsenga, Brussels (BE)

(73) Assignees: Katholieke Universiteit Leuven, Leuven (BE); IMEC, Leuven (BE)

(21) Appl. No.: 13/622,964

(22) Filed: Sep. 19, 2012

Related U.S. Application Data
(63) Continuation of application No. 13/213,976, filed on Aug. 19, 2011, now abandoned.
Application No. 13/213,976 is a continuation of application No. PCT/EP2010/052063, filed on Feb. 18, 2010.
(60) Provisional application No. 61/153,808, filed on Feb. 19, 2009.

(30) Foreign Application Priority Data
May 13, 2009 (EP) 09160177.3

(51) Int. Cl. H04B 7/04

(52) U.S. Cl. CPC H04B 7/0408
USPC 455/63.4

(57) ABSTRACT

A method of analog beamforming in a wireless communication system is disclosed. The system has a plurality of transmit antennas and receive antennas. In one aspect, the method includes determining information representative of communication channels formed between a transmit antenna and a receive antenna of the plurality of antennas, defining a set of coefficients representing jointly the transmit and the receive beamforming coefficients, determining a beamforming cost function using the information and the set of coefficients, determining an optimized set of coefficients by exploiting the beamforming cost function, and separating the optimized set of coefficients into optimized transmit beamforming coefficients and optimized receive beamforming coefficients.

### CROSS REFERENCE TO RELATED APPLICATIONS

This application is a continuation of co-pending U.S. patent application Ser. No. 13/213,976, filed Aug. 19, 2011, which is a continuation of PCT Application No. PCT/EP2010/052063, filed Feb. 18, 2010, which claims priority under 35 U.S.C. §119(e) to U.S. provisional patent application 61/153,808 filed Feb. 19, 2009. Each of the above applications is incorporated herein by reference in its entirety.

### BACKGROUND OF THE INVENTION

1. Field of the Invention

The disclosed technology generally relates to wireless networks and in particular to beamforming transmissions in wireless networks.

2. Description of the Related Technology

The huge bandwidth available in the 60 GHz band allows short-range wireless communications to deliver data rate beyond 1 Gbps. However, the high pathloss and low output power of CMOS power amplifiers (PA) at 60 GHz yields poor link budget, making impossible to support such high data rate with omni-directional antenna. A key solution to the link budget problem at 60 GHz is to use multiple antenna beamforming.

Currently, most of the existing joint Transmit/Receive (Tx/Rx) BF designs for MIMO frequency selective channels use wideband (i.e. frequency-selective) Tx and Rx weights. Depending on the beamforming architecture, the weighting can be done either in the digital domain (digital beamforming (DBF)) or in the analog domain (analog beamforming (ABF)) using finite impulse response (FIR) filter weights. However, the power consumption of a DBF architecture is very high, since each antenna branch has its own complete up (or down)-conversion chain including a digital-to-analog converter (DAC) (or an analog-to-digital converter (ADC)). On the other hand, even though a FIR ABF architecture has only one Tx/Rx chain shared by different antennas, the analog implementation of FIR filter weights is very complex. Consequently, these two architectures are not suited for end-user 60 GHz wireless terminals.

To alleviate both high power consumption and high implementation complexity problems, a key solution is to use ABF architectures with scalar (i.e. frequency-flat) complex weights. However, the design of corresponding joint Tx/Rx ABF algorithms is challenging in the case of frequency selective channels due to this constraint of a scalar weight per antenna.

A typical optimization problem is formulated by

$$( {\underline{w}}_{opt} , {\underline{c}}_{opt} ) = arg {max}_{\underline{w} , \underline{c}} \frac{{\underline{c}}^{H} {{P}_{\underline{\_}}}_{( \underline{w} )} \underline{c}}{{\underline{c}}^{H} \underline{c}} ,$$

with wₒₚₜ the optimal transmit weight vector and cₒₚₜ the optimal receive weight vector and P_{(w)} defined by

$${{P}_{\underline{\_}}}_{( \underline{w} )} = {\sum }_{l}^{ } {H}_{\underline{\_}} [ l ] \underline{w} {\underline{w}}^{H} {{H}_{\underline{\_}}}^{H} [ l ]$$

(with H the overall channel response and w a vector of transmit beamforming coefficients). While the computation of cₒₚₜ is straightforward, the computation of wₒₚₜ is a non-linear optimization problem. Note that for flat MIMO channels the optimization problem can be simplified since P_{(w)} is a rank one matrix. In that case, the largest eigenvalue optimization problem is equivalent to maximizing the trace of P_{(w)}. However, in the case of MIMO multipath channels, P_{(w)} is not a rank one matrix. Consequently, the maximum eigenvalue optimization problem cannot be solved directly via the optimization problem of the trace.

An iterative joint Tx/Rx ABF algorithm that takes this constraint into account is proposed in ‘MIMO beamforming for high bit rate transmission over frequency selective channels’, (H. Hoang Pham et al., IEEE Eighth Int'l Symposium on Spread Spectrum Techniques and Applications, pp. 275-279, 2004). The Tx and Rx weights are computed to maximize the Signal to Noise Ratio (SNR), where the energy in the delayed paths is treated as additional noise. Nevertheless, this ABF optimization approach is sub-optimal if an equalizer is to be used afterwards. Moreover, this approach requires a complete knowledge of all Tx/Rx channel impulse response (CIR) pairs of the MIMO channel at both Tx and Rx sides. The acquisition of this information in real-time operation is costly for large delay spread channels.

In US patent application US 2008/0204319, an iterative beam acquisition process based on beam search training is performed, thereby determining transmit and receive beamforming vectors including phase weighting coefficients. Each iteration involves estimating receive and transmit beamforming coefficients alternatively, until the receive and transmit beamforming coefficients converge. This optimization process can converge to a local minimum.

### SUMMARY OF CERTAIN INVENTIVE ASPECTS

Certain inventive aspects relate to a method of analog beamforming in a wireless communication system wherein the need for solving a non-linear problem for determining the transmit and receive beamforming coefficients is avoided.

One inventive aspect relates to a method of analog beamforming in a wireless communication system having a plurality of transmit antennas and receive antennas. The method comprises determining transmit beamforming coefficients and receive beamforming coefficients by: a) determining information representative of communication channels formed between a transmit antenna and a receive antenna of the plurality of antennas, b) defining a set of coefficients representing jointly the transmit and receive beamforming coefficients, c) determining a beamforming cost function by using this information and the set of coefficients, d) calculating an optimized set of coefficients by exploiting this beamforming cost function, e) separating the optimized set of coefficients into optimized transmit beamforming coefficients and optimized receive beamforming coefficients.

In one embodiment the process of determining information representative of communication channels comprises determining a channel pair matrix having elements representative of channel pairs formed between a transmit antenna and a receive antenna of the plurality of antennas. In particular, this matrix comprises the inner products between a channel pair. Furthermore, the process of determining an initial set of coefficients representing the transmit and receive beamforming coefficients comprises defining a joint transmit and receive vector, defined by d^{H}=w^{T} [symbol] c^{H}. The process of separating the optimized set of coefficients is performed by a vector decomposition.

Further, a beamforming cost function is determined by means of this channel pair matrix and the joint transmit and receive vector. The cost function is optimized and thereby the optimized joint transmit and receive vector is determined. This optimized joint transmit and receive vector is preferably determined by calculating the principal eigenvector of the channel pair matrix e.g. via eigenvalue decomposition (EVD) of the channel pair matrix. The optimized joint transmit and receive vector is separated into a transmit beamforming vector and a receive beamforming vector by a vector decomposition of the optimized joint transmit and receive vector e.g. Schmidt decomposition.

By optimizing a joint analog beamforming coefficient, a non-linear optimization problem is avoided. One inventive aspect relates to a method for joint TX/RX ABF optimization, where the energy in the delayed paths is exploited to increase the average symbol energy at the input of the equalizer. The required channel pair matrix or the channel state information (CSI) for joint TX/RX ABF optimization is only the inner products between all Tx/Rx pairs. The amount of CSI to be estimated in real-time depends only on the number of TX and Rx antennas and not on the time dispersion due to the channel.

In another embodiment the method of analog beamforming in a wireless communication system further comprises a) selecting a set of coefficients representing predetermined transmit and receive beamforming coefficients for each of a required number of antenna training periods, b) transmitting a periodic training sequence with a predetermined coefficient in that number of antenna training periods, whereby the predetermined coefficient is selected from the set of coefficients, c) receiving the transmitted training sequences, d) determining dependency relations between the received training sequences at each of the antenna training periods and e) determining an estimate of the information representative of communication channels by means of the dependency relations and the set of coefficients.

In particular, the number of antenna training periods is defined by the multiplication of the number of transmit antennas and the number of receive antennas, n_{T}×n_{R}. They are organized in a covariance matrix comprising the covariance between the received training sequences at each of the antenna training periods. Preferably, also the set of coefficients is organized in a joint matrix comprising columns of a joint transmit and receive vector used in the antenna training periods. Furthermore, this joint matrix is a unitary matrix.

The channel pair matrix is estimated by means of the covariance matrix and the joint transmit and receive matrix. For a large time dispersion channel

$$( L > \frac{{n}_{R} \times {n}_{T} + 1}{2} ) ,$$

the complexity of estimating this channel pair matrix is independent of the channel time dispersion because if one had to estimate each individual channel pair instead of the inner products between them, then the number of elements to be estimated would be n_{R}×n_{T}×L. Thus for large time dispersive channels, the lower complexity solution is to estimate the inner products.

In another aspect, there is a station (a transceiver) for use in a wireless communication system, preferably a 60 GHz communication system. The station is preferably implemented as a receiver device. However, an implementation as a transmitter device can be envisaged as well.

The receiver device comprises a plurality of receive antennas and an estimator arranged for determining information representative of communication channels formed between a receive antenna of the plurality of receive antennas and a transmit antenna of a plurality of transmit antennas of a transmitter device of the wireless communication system. The receiver device is further provided with a controller device arranged for calculating an optimized set of coefficients based on a beamforming cost function using the information obtained in the estimator and a set of initial coefficients representing jointly the transmit and receive beamforming coefficients. The controller device is further also arranged for separating the optimized set of coefficients into optimized transmit beamforming coefficients and optimized receive beamforming coefficients. The receiver device is also arranged for sending the optimized transmit beamforming coefficients to the transmitter device. This may be done via a control channel on which no analog beamforming is applied. In a typical implementation such a channel also has a signal-to-noise ratio substantially larger than on the above-mentioned communication channels between a transmit and a receive antenna.

As already mentioned, in a specific embodiment a transmitter device arranged for determining the optimized set of coefficients and for dividing the optimized coefficients into transmit coefficients and receive coefficients and sending the receive coefficients to the receiver device at the other side of the communication channels. More in particular, one inventive aspect relates to a transmitter device comprising a plurality of transmit antennas and an estimator arranged for determining information representative of communication channels formed between a transmit antenna of the plurality of transmit antennas and a receive antenna of a plurality of receive antennas of a receiver device of the wireless communication system. The transmitter device is further provided with a controller device arranged for calculating an optimized set of coefficients based on a beamforming cost function using the information obtained in the estimator and a set of initial coefficients representing jointly the transmit and receive beamforming coefficients. The controller device is further also arranged for separating the optimized set of coefficients into optimized transmit beamforming coefficients and optimized receive beamforming coefficients. The transmitter device is also arranged for sending the optimized receive beamforming coefficients to the receiver device.

### BRIEF DESCRIPTION OF THE DRAWINGS

The invention will be further elucidated by means of the following description and the appended figures.

FIG. 1 illustrates a MIMO transceiver system in one embodiment.

FIG. 2 represents a flowchart for retrieving transmit and receive weights in one embodiment.

FIG. 3 represents a plot of the BER as function of the input SNR in one embodiment.

FIG. 4 illustrates the performance of the proposed CSI estimator in one embodiment.

FIG. 5 shows a flowchart of one embodiment of a method of analog beamforming in a wireless communication system having a plurality of transmit antennas and receive antennas.

FIG. 6 shows a block diagram illustrating one embodiment of a device for use in a wireless communication system. The device 200 could be a transmitter device or a receiver device.

### DETAILED DESCRIPTION OF CERTAIN ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein can operate in other orientations than described or illustrated herein.

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting of only components A and B. It means that with respect to the present invention, the only relevant components of the device are A and B.

Certain embodiments relate to a method of analog beamforming in a wireless communication system having a plurality of transmit antennas and receive antennas. A channel pair is formed between a transmit antenna and a receive antenna of this plurality of antennas. The method comprises determining a beamforming cost function by means of a matrix representing the communication channel and a joint transmit and receive vector. Via an optimization technique, this joint transmit and receive vector may be derived. Further, this optimized joint transmit and receive vector will be separated into a transmit beamforming vector and a receive beamforming vector via a vector decomposition.

In the description, following notations are used. Roman letters represent scalars, single underlined letters denote column vectors and double underlined letters represent matrices. The notations [.]^{T}, [.]^{H} and [.]* stand for transpose, complex conjugate transpose and conjugate transpose operators, respectively. The expectation operator is denoted by ε[.]. The symbol [symbol] denotes the Kronecker product. The element of X in k-th row and 1-th column is represented by [X]_{(k,l)}. The notation Iₖ represents the identity matrix of size k×k.

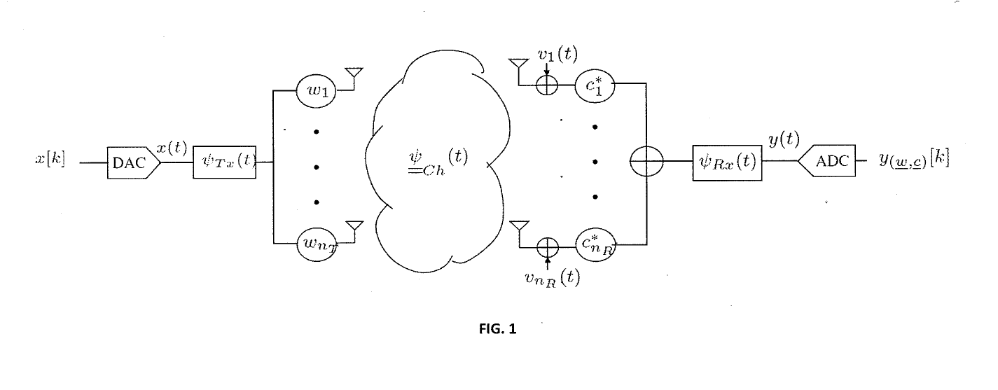

First a system model is introduced. A multi-antenna wireless system is considered with n_{T} transmit antennas and n_{R} receive antennas. Both the Tx and Rx front-ends (FE) are based on an ABF architecture as shown in FIG. 1. In this system configuration only one digital stream x[k] can be transmitted. In the following, the expression of the discrete-time channel impulse response (CIR) as a function of Tx/Rx scalar weights is derived. From the Tx DAC to the Rx ADC, one has successively: a Tx pulse shaping filter ψ_{Tx}(t), a splitter, n_{T} Tx scalar weights w:=[w₁ w₂ . . . wₙ_{_{T}}]^{T}, a wireless frequency selective MIMO channel ψ_{Ch}(t), n_{R} Rx scalar weights c^{H}:=[c₁* c₂* . . . cₙ_{_{R}}*], a combiner and finally a Rx pulse shaping filter ψ_{Rx}(t). The overall MIMO channel response of the cascade of the Tx filter, the continuous MIMO channel and the Rx filter is denoted \tilde{H}(t):=ω_{Tx}(t)*ψ_{Ch}(t)*ψ_{Rx}(t). Since the symbol rate is very high, it is assumed in the sequel that the channel conditions stay invariant during the transmission of several bursts. The equivalent discrete-time expression of the MIMO channel, defined as \tilde{H}[k]:=\tilde{H}(t)l_{t=kT} is given by:

$${\tilde{H}}_{\underline{\_}} [ k ] = {\sum }_{l = 0}^{L - 1} {H}_{\underline{\_}} [ l ] δ [ k - l ] , \qquad ( 1 )$$

where L denotes the number of discrete-time multipath components and the matrix H[l] represents the MIMO channel response after a time delay equal to l symbol periods. The latter matrix is defined as:

$${H}_{\underline{\_}} [ l ] = [ \begin{matrix}{h}_{1 , 1} [ l ] & {h}_{1 , 2} [ l ] & & {h}_{1 , {n}_{T}} [ l ] \\ {h}_{2 , 1} [ l ] & {h}_{2 , 2} [ l ] & & {h}_{2 , {n}_{T}} [ l ] \\ ⋮ & ⋮ & ⋱ & ⋮ \\ {h}_{{n}_{R} , 1} [ l ] & {h}_{{n}_{R} , 2} [ l ] & & {h}_{{n}_{R} , {n}_{T}} [ l ]\end{matrix} ] , \qquad ( 2 )$$

where h_{i,j}[l] is the complex gain of the l^{th} tap of the aggregate CIR between the i^{th} receive antenna and the j^{th} transmit antenna.

Taking into account the Tx and Rx scalar weights, the discrete-time single input single output (SISO) CIR is given by:

$${\tilde{h}}_{( \underline{w} , \underline{c} )} [ k ] = {\underline{c}}^{H} ( {\sum }_{l = 0}^{L - 1} {H}_{\underline{\_}} [ l ] δ [ k - l ] ) \underline{w} . \qquad ( 3 )$$

Furthermore, each receiver branch is corrupted by additive white Gaussian noise (AWGN) of variance σᵥ². Since the AWGN on different Rx antennas are mutually independent, it can be shown that the variance of the resulting AWGN after Rx combining, denoted n_{(c)}(t), is given by:

$${σ}_{{n}_{( \underline{c} )}}^{2} = {σ}_{v}^{2} {\underline{c}}^{H} \underline{c} . \qquad ( 4 )$$

Finally, the discrete-time input-output relationship is given by

$${y}_{( \underline{w} , \underline{c} )} [ k ] = {\underline{c}}^{H} ( {\sum }_{l = 0}^{L - 1} {H}_{\underline{\_}} [ l ] x [ k - l ] ) \underline{w} + {n}_{( \underline{c} )} [ k ] . \qquad ( 5 )$$

The key challenge in finding optimal weights w and c is that, being scalar, they are identical for all multipath delays l in (5).

In a first process a joint transmit and receive vector is determined based on maximising the average SNR at the input of an equalizer. Firstly, a BF cost function is defined based on the average SNR criterion, where the energy in the delayed paths is exploited to increase the symbol energy at the input of the equalizer. Secondly, the ABF optimization problem is stated. Finally, a low complexity algorithm is proposed to compute close-to-optimal Tx/Rx scalar weights according to this criterion.

### Beamforming Cost Function

The considered SNR metric is denoted by Γ̅_{(w,c)}, which is a function of both Tx and Rx weights. Starting from (5) and assuming a zero-mean independent and identically distributed (i.i.d) sequence x[k] with variance σₓ², the calculation of Γ̅_{(w,c)} is given by

$${\overline{Γ}}_{( \underline{w} , \underline{c} )} [ k ] = {\overline{Γ}}_{0} \frac{{\sum }_{l = 0}^{L - 1} {\vert {\underline{c}}^{H} {H}_{\underline{\_}} [ l ] \underline{w} \vert}^{2}}{{\underline{c}}^{H} \underline{c}} \qquad ( 6 )$$

where

$${\overline{Γ}}_{0} = \frac{{σ}_{x}^{2}}{{σ}_{v}^{2}}$$

is the average input SNR.
In the numerator of (6) the energy of all taps of the multipath is considered. In the sequel, the resulting optimization problem is described.

### Optimization Problem Statement

The beamforming cost function expression (6) is rewritten as

$$\begin{matrix}{\overline{Γ}}_{( \underline{w} , \underline{c} )} = {\overline{Γ}}_{0} \frac{{\underline{c}}^{H} {{P}_{\underline{\_}}}_{( \underline{w} )} \underline{c}}{{\underline{c}}^{H} \underline{c}} , & ( 7 ) \\ where & \\ {{P}_{\underline{\_}}}_{( \underline{w} )} = {\sum }_{l}^{ } {H}_{\underline{\_}} [ l ] \underline{w} {\underline{w}}^{H} {{H}_{\underline{\_}}}^{H} [ l ] . & ( 8 )\end{matrix}$$

The resulting optimization problem is formulated as

$$( {\underline{w}}_{opt} , {\underline{c}}_{opt} ) = arg {max}_{\underline{w} , \underline{c}} \frac{{\underline{c}}^{H} {{P}_{\underline{\_}}}_{( \underline{w} )} \underline{c}}{{\underline{c}}^{H} \underline{c}} . \qquad ( 9 )$$

In order to keep the total transmitted power constant, the norm of w is constrained to unity. Moreover, to retain the average SNR calculations to the input SNR, the Rx weight vector c is normalized such that: c^{H}c=1.

It is known that for a given w the vector that maximizes (7), denoted by cₒₚₜ(w), corresponds to the principal eigenvector of P_{(w)} and Γ̅_{(w,c}_{ₒₚₜ}(w)) equals the largest eigenvalue of P_{(w)}. Hence, the joint Tx/Rx ABF optimization problem can be solved as follows.
Find the Tx weight w that maximizes the largest eigenvalue of P_{(w)}, denoted by wₒₚₜ

$${\underline{w}}_{opt} = arg {max}_{\underline{w}} {λ}_{max} ( {{P}_{\underline{\_}}}_{( \underline{w} )} ) . \qquad ( 10 )$$

Next, from the Eigen Value Decomposition (EVD) of P_{(w}_{ₒₚₜ}₎, the optimal Rx weight cₒₚₜ is chosen to be the principal eigenvector of P_{(w}_{ₒₚₜ}₎.

While the computation of cₒₚₜ is straightforward, the computation of wₒₚₜ is a non-linear optimization problem. Note that for flat MIMO channels the optimization problem can be simplified since P_{(w)} is a rank one matrix. In that case the largest eigenvalue optimization problem is equivalent to maximizing the trace of P_{(w)}. It can be easily shown that wₒₚₜ is then the principal eigenvector of H^{H}[0]H[0]. However, in the case of MIMO multipath channels, P_{(w)} is not a rank one matrix because of the summation in (8). Consequently, the maximum eigenvalue optimization problem cannot be solved directly via the optimization problem of the trace.

### Proposed Joint Tx/Rx ABF Optimization Algorithm

First the expression (6) is reformulated. A so called vec operator is hereby introduced. Such operator is well known in the field of linear algebra and creates a column vector from a matrix A by stacking the column vectors of A=[a1 a2 . . . an] below one another:

$$vec ( A ) = [ \begin{matrix}{a}_{1} \\ {a}_{2} \\ ⋮ \\ {a}_{n}\end{matrix} ]$$

By exploiting the vec operator property vec(A×B)=(B^{T} [symbol] A) vec(X), the scalar term c^{H}H[l]w from (6) can be rewritten as:

c^{H}H[l]w=(w^{T} [symbol] c^{H})vec(H[l]).

Substituting (11) into (6), one obtains:

Γ̅_{(w,c)}= Γ̅₀(w^{T} [symbol] c^{H})R(w^{T} [symbol] c^{H})^{H} (12)

where

$${ℛ}_{\underline{\_}} = {\sum }_{l = 0}^{L - 1} {vec ( {H}_{\underline{\_}} [ l ] ) [ vec ( {H}_{\underline{\_}} [ l ] ) ]}^{H} \qquad ( 13 )$$

It is shown below that the elements of [symbol] are inner products between MIMO CIR pairs. This matrix has a Hermitian structure and has a rank R=min{L,n_{R}×n_{T}}. A composite vector d is defined as

d^{H}=w^{T} [symbol] c^{H}. (14)

The vector d has N_{R}×N_{T} elements. Then the expression of the SNR gets a classical quadratic form

Γ̅_{(d)}= Γ̅₀d^{H} [symbol] d (15)

The optimization of (15) is done by computing the EVD of

[symbol]

$$\underline{\underline{ℛ}} = {\sum }_{r = 1}^{R} {λ}_{r} {\underline{q}}_{r} {\underline{q}}_{r}^{H} \qquad ( 16 )$$

where λ₁≧λ₂≧≧λ_{R}>0 are real-valued eigenvalues of [symbol] and q₁,q₂,q_{R} are the corresponding eigenvectors.

It is well known that the vector d that maximizes (15) corresponds to the principal eigenvector of [symbol] . Therefore dₒₚₜ=q₁.

In order to obtain separate Tx and Rx weight vectors, the vector dₒₚₜ must be expressed as a kronecker product of two vectors. In linear algebra, this is achieved by applying the Schmidt decomposition theory.

Let G_{T} and G_{R} be the Hilbert spaces of dimensions N_{T} and N_{R} respectively. Denoting by N=min(N_{R},N_{T}), for any vector d in the tensor product G_{T} [symbol] G_{R}, there exists orthonormal sets {t₁, . . . , t_{N}}⊂G_{T} and {r₁, . . . , r_{N}}⊂G_{R} such that

$$\underline{d} = {\sum }_{i = 1}^{N} {α}_{i} {\underline{t}}_{i} ⊗ {\underline{r}}_{i} . \qquad ( 17 )$$

The scalars αᵢ, known as Schmidt coefficients, are non-negative and are such that α₁>α₂> . . . >α_{N}>0. Since the number N of Schmidt coefficients is >1 the composite vector d is the to be entangled. A close-to-optimal solution is obtained by taking the best rank-1 approximation of the Schmidt decomposition of dₒₚₜ which yields w^{T}=t_{1,opt}^{H} and c=r_{1,opt}.

In the second process the inner products between the MIMO CIR pairs needs to be estimated. From the previous section it is known that the required CSI to compute the optimal Tx and Rx ABF weights is contained in the matrix [symbol] . The required CSI is now shown to be the inner product between channel impulse responses of all MIMO Tx/Rx pairs. Next, a method is proposed to acquire this CSI in real-time operation.

### Required CSI

Each element of [symbol] is an inner product between a pair of MIMO CIR. In fact, substituting (2) in (14), one can easily show the element [symbol] ₍ⱼ_{₁}_{,j}_{₂}₎ is given by

$$\begin{matrix}\begin{matrix}{\underline{\underline{[ ℛ ]}}}_{( {j}_{1} , {j}_{2} )} = {\sum }_{l = 0}^{L - 1} {h}_{{r}_{1} , {t}_{1}} [ l ] {h}_{{r}_{2} , {t}_{2}}^{*} [ l ] \\ = {\underline{h}}_{{r}_{2} , {t}_{2}}^{H} {\underline{h}}_{{r}_{1} , {t}_{1}}\end{matrix} \\ where & ( 18 ) \\ {j}_{i} = {n}_{R} ( {t}_{i} - 1 ) + {r}_{i} with \{ \begin{matrix}i = \{ 1 , 2 \} \\ {t}_{i} = \{ 1 , 2 , … , {n}_{T} \} \\ {r}_{i} = \{ 1 , 2 , … , {n}_{R} \}\end{matrix} & ( 19 )\end{matrix}$$

and h_{r,t}:=[h_{r,t}[0], h_{r,t}[1], . . . , h_{r,t}[L−1]]^{T} is the discrete-time CIR between the r^{th} Rx antenna and t^{th} Tx antenna.

### Proposed CSI Estimator

A method is now proposed to estimate the matrix [symbol] . Since this matrix is square and hermitian, the number of elements to be estimated is

$$\frac{( {n}_{R} \times {n}_{T} ) \times ( {n}_{R} \times {n}_{T} + 1 )}{2} .$$

If one had to estimate each individual MIMO CIR pair instead of the inner product between them, then the number of elements to be estimated would be n_{R}×n_{T}×L. Thus, for large time dispersive channels, where

$$L > \frac{{n}_{R} \times {n}_{T} + 1}{2} ,$$

the lower complexity solution is to estimate the inner products.

The proposed method is based on a repetitive transmission of a length-K i.i.d and zero mean training sequence, which is denoted by u[k] below. As set out below, the number of required training periods is n_{R}×n_{T}. In each training period different joint Tx/Rx weights are used.

Starting from (5) and using the vec operator property, the k^{th} symbol received during the m^{th} training period is given by

$${y}_{m} [ k ] = {\underline{d}}_{m}^{H} {\sum }_{l = 0}^{L - 1} vec ( \underline{\underline{H}} [ l ] ) u [ k - l ] + {n}_{( {\underline{c}}_{m} )} [ k ] , \qquad ( 20 )$$

where dₘ is defined as in (15). The covariance between the symbols received in the m₁^{th} and m₂^{th} periods is

σ_{y}²(m₁,m₂)=ε[yₘ_{₁}[k]yₘ_{₂}*[k]] (21)

Substituting (20) in (21), one obtains

$${σ}_{y}^{2} ( {m}_{1} , {m}_{2} ) = {\underline{d}}_{{m}_{1}}^{H} ( {\sum }_{{l}_{1} = 0}^{L - 1} {\sum }_{{l}_{2} = 0}^{L - 1} {vec ( \underline{\underline{H}} [ {l}_{1} ] ) [ vec ( \underline{\underline{H}} [ {l}_{2} ] ) ]}^{H} ) {\underline{d}}_{{m}_{2}} \times ɛ [ u [ k - {l}_{1} ] {u}^{*} [ k - {l}_{2} ] ] + ɛ [ {n}_{( {\underline{c}}_{{m}_{1}} )} [ k ] {n}_{( {\underline{c}}_{{m}_{2}} )}^{*} [ k ] ] + {\underline{d}}_{{m}_{1}}^{H} ( {\sum }_{l = 0}^{L - 1} vec ( \underline{\underline{H}} [ l ] ) ɛ [ {n}_{( {\underline{c}}_{{m}_{1}} )} [ k ] {u}^{*} [ k - l ] ] ) + ( {\sum }_{l = 0}^{L - 1} {[ vec ( \underline{\underline{H}} [ l ] ) ]}^{H} ɛ [ u [ k - l ] {n}_{( {\underline{c}}_{{m}_{2}} )}^{*} [ k ] ] ) {\underline{d}}_{{m}_{2}} \qquad ( 22 )$$

By exploiting the i.i.d and zero-mean property of the training sequence u[k]

$$ɛ [ u [ k - {l}_{1} ] {u}^{*} [ k - {l}_{2} ] ] = \{ \begin{matrix}{σ}_{u}^{2} & {l}_{1} = {l}_{2} \\ 0 & {l}_{1} \neq {l}_{2}\end{matrix}$$

the i.i.d property of AWGN

$$ɛ [ {n}_{( {\underline{c}}_{{m}_{1}} )} [ k ] {n}_{( {\underline{c}}_{{m}_{2}} )}^{*} [ k ] ] = \{ \begin{matrix}{σ}_{n}^{2} & δ ( {m}_{1} - {m}_{2} ) \\ 0 & \end{matrix}$$

the mutual independence between i.i.d sequence u[k] and AWGN

$$\begin{matrix}ɛ [ u [ k - l ] {n}_{( {\underline{c}}_{{m}_{2}}^{*} )} [ k ] ] \\ ɛ [ {n}_{( {\underline{c}}_{{m}_{1}} )} [ k ] {u}^{*} [ k - l ] ]\end{matrix} \} = 0 ∀ l$$

one obtains

σ_{y}²(m₁,m₂)=σᵤ²dₘ_{₁}^{H} [symbol] dₘ_{₂}+σₙ²δ(m₁−m₂) (23)

In order to obtain the same number of equations as unknowns, n_{R}×n_{T} training periods are needed. Therefore, after collecting the data received during all training periods, one can compute an n_{R}×n_{T} square matrix, denoted σ_{y}², such that [σ_{y}²]₍ₘ_{₁}_{,m}_{₂}₎=σ_{y}²(m₁,m₂ with m_{1/2}={1,2, . . . , n_{R}×n_{T}}. In matrix formulation, σ_{y}² is given by

σ_{y}²=σᵤ²D^{H} [symbol] D+σₙ²Iₙ_{_{R}}_{×n}_{_{T}} (24)

where the m^{th} column of D is the used joint Tx/Rx weight vector dₘ in the m^{th} training period.

If the Tx/Rx weight vector wₘ and cₘ that yield dₘ are selected such that the resulting D is a unitary matrix

D^{H}D=Iₙ_{_{T}}_{×n}_{_{R}}, (25)

an estimation of [symbol] is obtained by isolating in [symbol] in (24)

$$\begin{matrix}\underline{\underline{ℛ}} = \underline{\underline{D}} {\underline{\underline{σ}}}_{y}^{2} {\underline{\underline{D}}}^{H} \\ = {σ}_{u}^{2} \underline{\underline{ℛ}} + {σ}_{n}^{2} {\underline{\underline{I}}}_{{n}_{R} \times {n}_{T}} ( 27 )\end{matrix} \qquad ( 26 )$$

Note that, in practice, each covariance element [σ_{y}²]₍ₘ_{₁}_{,m}_{₂}₎ is approximated by

$${[ {\underline{\underline{σ}}}_{y}^{2} ]}_{( {m}_{1} , {m}_{2} )} ≅ \frac{1}{K} {\sum }_{k = 0}^{K - 1} {y}_{{m}_{1}} [ k ] {y}_{{m}_{2}}^{*} [ k ] . \qquad ( 28 )$$

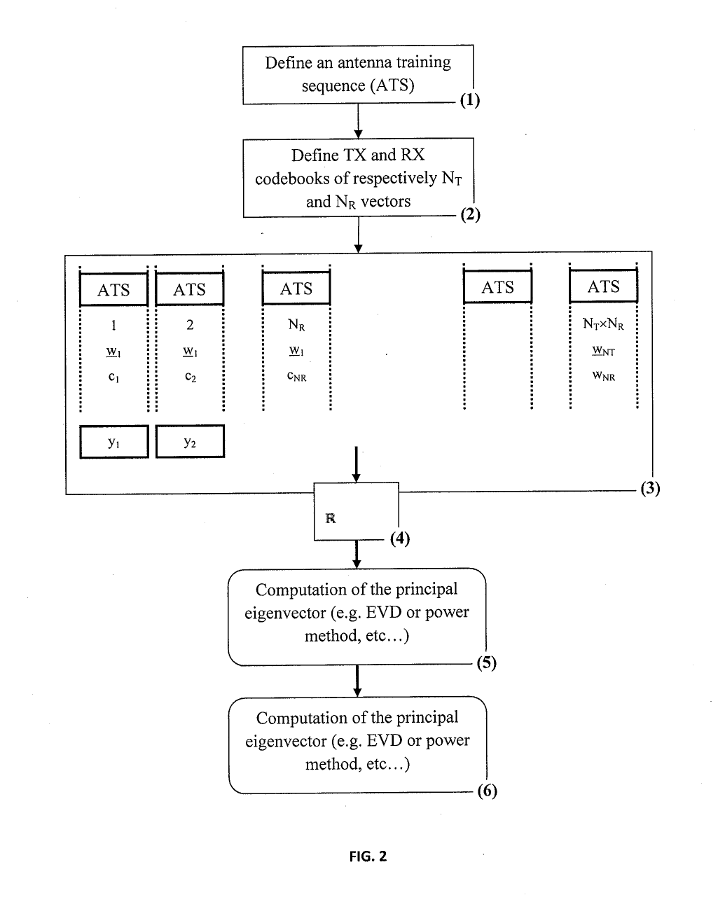

An overview of the estimation process is illustrated in FIG. 2. First, a training sequence is defined (1). This training sequence can be defined by the standard used or may be an optimized sequence of symbols proposed by the user. Secondly, a so called codebook or matrix D is defined (2), comprising coefficients representing predetermined jointly transmit and receive beamforming coefficients for each of the antenna training periods. Thirdly, the training sequence is transmitted for each antenna training period m with a predetermined coefficient (representing a transmit and a receive weight) selected from the codebook (3). Finally, an estimate of [symbol] (4) is computed (eq. 26). In a following process, the receive and transmit weight coefficients can be retrieved by computing the principal eigenvector of [symbol] (5), followed by a vector decomposition (6).

### Simulation Results

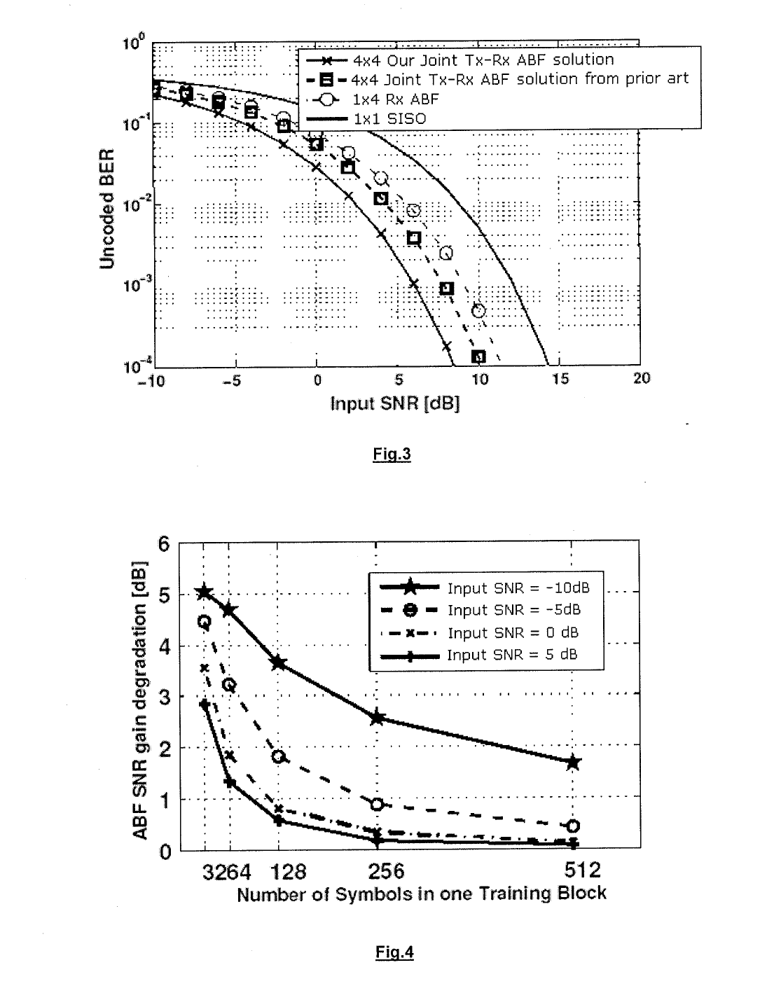

First the channel model used in the simulations is described. A 60 GHz multi-antenna ABF transceiver system is considered operating in an indoor environment. Each Tx/Rx pair CIR is generated using the CM23 model proposed by the IEEE 802.15.3c standardization body. Afterwards, the resulting MIMO channel is normalized such that the average received power is unitary. Firstly, the BER performances of the proposed joint Tx/Rx ABF algorithm are evaluated on a 4×4 MIMO transceiver with a single carrier (SC) QPSK-frequency domain equalizer (FDE) air interface. The results are shown in FIG. 3. It is observed that the scheme according to one embodiment (x-marked solid line) yields an ABF gain of 6 dB over a SISO system (solid line). Moreover, by applying a joint Tx/Rx ABF, the BER performance is improved by 3 dB over the scheme where ABF is only applied at the Rx (dashdot line with circle). Secondly, the performance of the proposed CSI estimator is evaluated by computing the degradation of the average ABF SNR at the input of the equalizer relative to the SNR with perfect CSI knowledge. The degradation is evaluated as a function of the training block length. The results are presented in FIG. 4. With a block of 512 symbols, the degradation is less than 1 dB, even at very low input SNR (−10 dB). As the block length decreases, the degradation increases due to errors introduced by the approximation in (28). On the other hand, as the input SNR increases, the performance of the estimator improves and the ABF SNR degradation is less than 0.1 dB with a 256-block length for an average SNR of −10 dB.

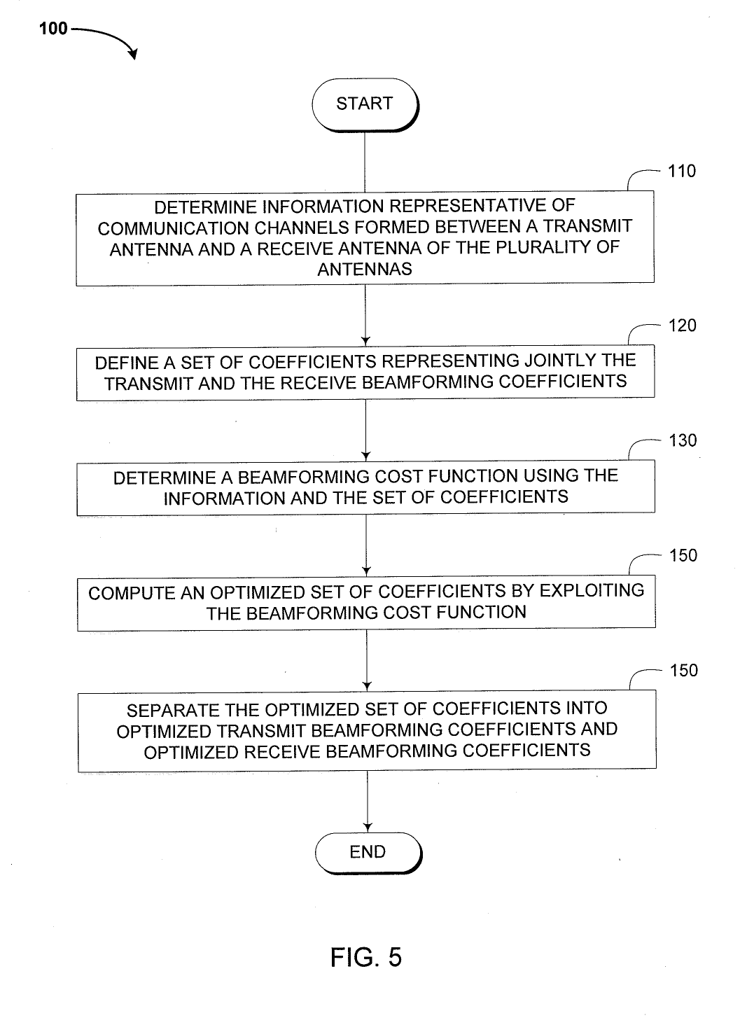

FIG. 5 shows a flowchart of one embodiment of a method of analog beamforming in a wireless communication system having a plurality of transmit antennas and receive antennas. The method 100 determines transmit beamforming coefficients and receive beamforming coefficients. The method 100 comprises at block 110 determining information representative of communication channels formed between a transmit antenna and a receive antenna of the plurality of antennas. Next in block 210, the method comprises defining a set of coefficients representing jointly the transmit and the receive beamforming coefficients. Moving to next block 130, the method comprises determining a beamforming cost function using the information and the set of coefficients. At block 140, the method comprises computing an optimized set of coefficients by exploiting the beamforming cost function. Moving to block 150, the method includes separating the optimized set of coefficients into optimized transmit beamforming coefficients and optimized receive beamforming coefficients.

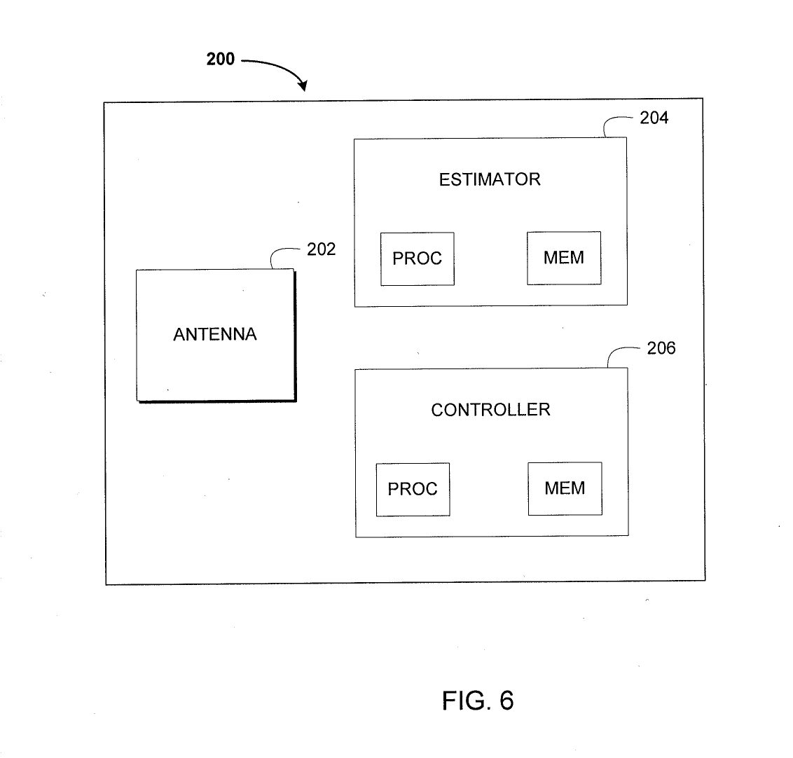

FIG. 6 shows a block diagram illustrating one embodiment of a device for use in a wireless communication system. The device 200 could be a transmitter device or a receiver device. The device 200 comprises a plurality of antennas 202. The antennas could be transmit antennas or receive antennas depending on whether the device 200 is a transmitter or a receiver. The device 200 further comprises an estimator 204 arranged for determining information representative of communication channels formed between a receive antenna of the plurality of receive antennas of a receiver device and a transmit antenna of a plurality of transmit antennas of a transmitter device of the wireless communication system. It should be noted that the device 200 is one of the transmitter device and the receiver device in communication. The device 200 may further comprise a controller 206 arranged for calculating an optimized set of coefficients based on a beamforming cost function using the information obtained in the estimator and a set of initial coefficients representing jointly the transmit and receive beamforming coefficients, the controller further being arranged for separating the optimized set of coefficients into optimized transmit beamforming coefficients and optimized receive beamforming coefficients. In one embodiment, the device 200 sends the optimized transmit beamforming coefficients to the other device with which it is communication.

In one embodiment, the estimator and/or the controller may optionally comprise a processor and/or a memory. In another embodiment, one or more processors and/or memories may be external to one or both of them. Furthermore, a computing environment may contain a plurality of computing resources which are in data communication.

Although systems and methods as disclosed, is embodied in the form of various discrete functional blocks, the system could equally well be embodied in an arrangement in which the functions of any one or more of those blocks or indeed, all of the functions thereof, are realized, for example, by one or more appropriately programmed processors or devices.

It is to be noted that the processor or processors may be a general purpose, or a special purpose processor, and may be for inclusion in a device, e.g., a chip that has other components that perform other functions. Thus, one or more aspects of the present invention can be implemented in digital electronic circuitry, or in computer hardware, firmware, software, or in combinations of them. Furthermore, aspects of the invention can be implemented in a computer program product stored in a computer-readable medium for execution by a programmable processor. Method steps of aspects of the invention may be performed by a programmable processor executing instructions to perform functions of those aspects of the invention, e.g., by operating on input data and generating output data. Accordingly, the embodiment includes a computer program product which provides the functionality of any of the methods described above when executed on a computing device. Further, the embodiment includes a data carrier such as for example a CD-ROM or a diskette which stores the computer product in a machine-readable form and which executes at least one of the methods described above when executed on a computing device.

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope.

1. A method of analog beamforming in a wireless communication system having a plurality of transmit antennas and receive antennas, the method comprising determining transmit beamforming coefficients and receive beamforming coefficients by:
determining information representative of communication channels formed between a transmit antenna and a receive antenna of the plurality of antennas;
defining a set of coefficients representing jointly the transmit and the receive beamforming coefficients;
determining a beamforming cost function using the information and the set of coefficients;
computing an optimized set of coefficients by exploiting the beamforming cost function; and
separating the optimized set of coefficients into optimized transmit beamforming coefficients and optimized receive beamforming coefficients with tensor product factorization.

2. The method of analog beamforming in a wireless communication system as in claim 1, wherein the process of determining information representative of communication channels comprises determining a channel pair matrix having elements representative of channel pair formed between a transmit antenna and a receive antenna of the plurality of antennas.

3. The method of analog beamforming in a wireless communication system as in claim 2, wherein the channel pair matrix is defined by
$$\underline{\underline{ℛ}} = {\sum }_{l = 0}^{L - 1} {vec ( \underline{\underline{H}} [ l ] ) [ vec ( \underline{\underline{H}} [ l ] ) ]}^{H}$$
wherein L denotes the number of discrete-time multipath components, H[l] represents the MIMO channel response after a time delay equal to l symbol periods, [.]^{H} stands for the complex conjugate transpose operator and vec denotes a matrix operator for creating a column vector.

4. The method of analog beamforming in a wireless communication system as in claim 1, wherein the process of defining a set of coefficients representing jointly the transmit and receive beamforming coefficients comprises defining a joint transmit and receive vector, defined by d^{H}=w^{T} [symbol] c^{H}, wherein w denote the transmit beamforming coefficients, c the receive beamforming coefficients and [symbol] the Kronecker product.

5. The method of analog beamforming in a wireless communication system as in claim 1, wherein the process of separating the optimized set of coefficients is performed by a vector decomposition.

6. The method of analog beamforming in a wireless communication system as in claim 1, the method further comprising:
selecting a set of coefficients representing predetermined transmit and receive beamforming coefficients for a number of antenna training periods;
transmitting a periodic training sequence with a predetermined coefficient in the number of antenna training periods, the predetermined coefficient being selected from the set of coefficients;
receiving the training sequences;
determining dependency relations between the received training sequences at each of the antenna training periods; and
determining an estimate of the information representative of communication channels by the dependency relations and the set of coefficients.

7. The method of analog beamforming in a wireless communication system as in claim 6, wherein the number of antenna training periods is defined by the multiplication of the number of receive antennas and the number of transmit antennas.

8. The method of analog beamforming in a wireless communication system as in claim 6, wherein the dependency relations are organized in a covariance matrix comprising the covariance between the received training sequences at each of the antenna training periods.

9. The method of analog beamforming in a wireless communication system as in claim 6, wherein the set of coefficients is organized in a joint matrix comprising columns of a used joint transmit and receive vector in each of the antenna training periods and wherein the joint matrix is a unitary matrix.

10. A non-transitory computer-readable medium having stored therein instruction which, when executed by a processor, performs the method as in claim 1.

11. A receiver device for use in a wireless communication system, the device comprising:
a plurality of receive antennas;
an estimator arranged for determining information representative of communication channels formed between a receive antenna of the plurality of receive antennas and a transmit antenna of a plurality of transmit antennas of a transmitter device of the wireless communication system; and
a controller arranged for calculating an optimized set of coefficients based on a beamforming cost function using the information obtained in the estimator and a set of initial coefficients representing jointly the transmit and receive beamforming coefficients, the controller further being arranged for separating the optimized set of coefficients into optimized transmit beamforming coefficients and optimized receive beamforming coefficients with tensor product factorization, wherein the receiver device sends the optimized transmit beamforming coefficients to the transmitter device.

12. The receiver device as in claim 11, wherein the estimator is configured to determine a channel pair matrix having elements representative of channel pair formed between a transmit antenna and a receive antenna of the plurality of antennas.

13. The receiver device as in claim 11, wherein the controller is configured to separate the optimized set of coefficients through a vector decomposition.

14. The receiver device as in claim 13, wherein the channel pair matrix is defined by
$$\underline{\underline{ℛ}} = {\sum }_{l = 0}^{L - 1} {vec ( \underline{\underline{H}} [ l ] ) [ vec ( \underline{\underline{H}} [ l ] ) ]}^{H}$$
wherein L denotes the number of discrete-time multipath components, H[l] represents the MIMO channel response after a time delay equal to l symbol periods, [.]^{H} stands for the complex conjugate transpose operator and vec denotes a matrix operator for creating a column vector.

15. A transmitter device for use in a wireless communication system, the device comprising:
a plurality of transmit antennas;
an estimator arranged for determining information representative of communication channels formed between a transmit antenna of the plurality of transmit antennas and a receive antenna of a plurality of receive antennas of a receiver device of the wireless communication system; and
a controller arranged for calculating an optimized set of coefficients based on a beamforming cost function using the information obtained in the estimator and a set of initial coefficients representing jointly the transmit and receive beamforming coefficients, the controller further being arranged for separating the optimized set of coefficients into optimized transmit beamforming coefficients and optimized receive beamforming coefficients with tensor product factorization, wherein the transmitter device sends the optimized receive beamforming coefficients to the receiver device.

16. The transmitter device as in claim 15, wherein the estimator is configured to determine a channel pair matrix having elements representative of channel pair formed between a transmit antenna and a receive antenna of the plurality of antennas.

17. The transmitter device as in claim 15, wherein the controller is configured to separate the optimized set of coefficients through a vector decomposition.

18. The transmitter device as in claim 15, wherein the channel pair matrix is defined by
$$\underline{\underline{ℛ}} = {\sum }_{l = 0}^{L - 1} {vec ( \underline{\underline{H}} [ l ] ) [ vec ( \underline{\underline{H}} [ l ] ) ]}^{H}$$
wherein L denotes the number of discrete-time multipath components, H[l] represents the MIMO channel response after a time delay equal to l symbol periods, [.]^{H} stands for the complex conjugate transpose operator and vec denotes a matrix operator for creating a column vector.

19. A system for analog beamforming in a wireless communication system having a plurality of transmit antennas and receive antennas, the system comprising:
means for determining information representative of communication channels formed between a transmit antenna and a receive antenna of the plurality of antennas;
means for defining a set of coefficients representing jointly the transmit and the receive beamforming coefficients;
means for determining a beamforming cost function using the information and the set of coefficients;
means for computing an optimized set of coefficients by exploiting the beamforming cost function; and
means for separating the optimized set of coefficients into optimized transmit beamforming coefficients and optimized receive beamforming coefficients with tensor product factorization.

20. The system as in claim 19, the system further comprising:
means for selecting a set of coefficients representing predetermined transmit and receive beamforming coefficients for a number of antenna training periods;
means for transmitting a periodic training sequence with a predetermined coefficient in the number of antenna training periods, the predetermined coefficient being selected from the set of coefficients;
means for receiving the training sequences;
means for determining dependency relations between the received training sequences at each of the antenna training periods; and
means for determining an estimate of the information representative of communication channels by the dependency relations and the set of coefficients.
